(19) United States
(12) Patent Application Publication
(10) Pub. No.: US 2015/0334557 A1
(43) Pub. Date: Nov. 19, 2015

(54) INFORMATION DISPLAY APPARATUS, IN-VEHICLE APPARATUS, AND DATA UPDATE METHOD

(71) Applicant: TOYOTA JIDOSHA KABUSHIKI KAISHA, Toyota-shi (JP)

(72) Inventors: Akira SASAKI, Toyota-shi (JP); Taisuke TONE, Toyota-shi (JP)

(21) Appl. No.: 14/680,327

(22) Filed: Apr. 7, 2015

(30) Foreign Application Priority Data
May 13, 2014 (JP) 2014-099786

(51) Int. Cl. H04W 8/20; H04M 3/493; G06F 17/30; H04M 3/42

(52) U.S. Cl. CPC H04W 8/20; H04M 3/42059; H04M 3/493; G06F 17/30554; G06F 17/30528; G06F 17/30864

(57) ABSTRACT

An information display apparatus configured to display database information obtained from an outside, includes a control unit configured to execute control for, when newly obtaining the database information from the outside, obtaining history information about the database information to be newly obtained from the outside, earlier than obtaining the database information to be newly obtained, and associating the history information with the database information that has already been obtained, to display the history information including the database information that has already been obtained.

### FIELD

The disclosures herein generally relate to an in-vehicle apparatus.

### BACKGROUND

Wireless communication between an in-vehicle apparatus such as a navigation apparatus, and a mobile terminal such as a cellular phone or a smart phone has become available. This makes it possible for a user (passenger) to operate such an in-vehicle apparatus so that the in-vehicle apparatus has a mobile terminal make a request to perform external communication. Thus, the user can have the mobile terminal make a request for external communication without operating the mobile terminal, and hence, can concentrate on driving.

Also, since wireless communication between an in-vehicle apparatus and a mobile terminal has become available, data such as telephone directory data or history data can be automatically transferred from the mobile terminal to the in-vehicle apparatus. Specifically, when a user carrying a mobile terminal comes within a range where communication can be made with an in-vehicle apparatus, wireless communication starts between the in-vehicle apparatus and the mobile terminal. Once the wireless communication starts between the in-vehicle apparatus and the mobile terminal, data such as telephone directory data or history data is transferred by wireless transmission from the mobile terminal to the in-vehicle apparatus, and the telephone directory data or the history data stored in the in-vehicle apparatus is updated. Thus, when operating the in-vehicle apparatus, the user can use the same telephone directory data and history data as those in the mobile terminal.

A technology has been known for an in-vehicle apparatus, with which a passenger can make operations without a delay for update timing of a telephone directory (see, for example, Patent Document 1).

### RELATED-ART DOCUMENTS

### Patent Documents

[Patent Document 1] Japanese Laid-open Patent Publication No. 2012-89938

When transferring telephone directory data and history data from a mobile terminal to an in-vehicle apparatus, it may take five to ten minutes until the data is displayed on the in-vehicle apparatus. Namely, it may take five to ten minutes for a user coming into a vehicle to be able to refer to a history list, and to recognize a missed call if there has been any.

From the usability point of view for a passenger coming into a vehicle, it is preferable that the history data is first transferred from a mobile terminal to an in-vehicle apparatus, followed by the telephone directory data, because the passenger can first recognize there has been a missed call. Suppose that the history data and the telephone directory data are transferred from the mobile terminal in this order. In this case, while the telephone directory data is being transferred after the history data has been transferred, only telephone numbers in the history list can be displayed based on the history data because the telephone directory data has not yet been obtained by the in-vehicle apparatus. Therefore, if the user makes a call with reference to the history list, the user may not know who the other party is because the full name or name of the missed caller is yet to be known.

It is an object of at least one embodiment of the present invention to display a history list including the full name or name corresponding to a telephone number in history data when obtaining the history data before the telephone directory data from the mobile terminal.

### SUMMARY

According to at least one embodiment of the present invention, an information display apparatus configured to display database information obtained from an outside, includes a control unit configured to execute control for, when newly obtaining the database information from the outside, obtaining history information about the database information to be newly obtained from the outside, earlier than obtaining the database information to be newly obtained, and associating the history information with the database information that has already been obtained, to display the history information including the database information that has already been obtained.

According to at least one embodiment of the present invention, it is possible to display a history list including the full name or name corresponding to a telephone number in history data when obtaining the history data before the telephone directory data from the mobile terminal.

### BRIEF DESCRIPTION OF DRAWINGS

FIG. 1 is a diagram illustrating an in-vehicle apparatus and a mobile terminal according to an embodiment;

FIG. 2 is a diagram illustrating a hardware configuration of an in-vehicle apparatus according to an embodiment;

FIG. 3 is a diagram illustrating a hardware configuration of a mobile terminal according to an embodiment;

FIG. 4 is a diagram illustrating a functional block diagram of an in-vehicle apparatus and a mobile terminal according to an embodiment;

FIG. 5 is a flowchart illustrating operations of an in-vehicle apparatus and a mobile terminal according to an embodiment;

FIG. 6 is a diagram illustrating an example of a display showing that a history list is being updated;

FIG. 7 is a diagram illustrating a first update example of a history list; and

FIG. 8 is a diagram illustrating a second update example of a history list.

### DESCRIPTION OF EMBODIMENTS

In the following, embodiments of the present invention will be described with reference to the drawings. The following embodiments are just examples, and the present invention is not limited to the following embodiments. Note that the same numerical codes are used for elements having the same functions throughout the drawings, and their description may not be repeated.

<Embodiments>

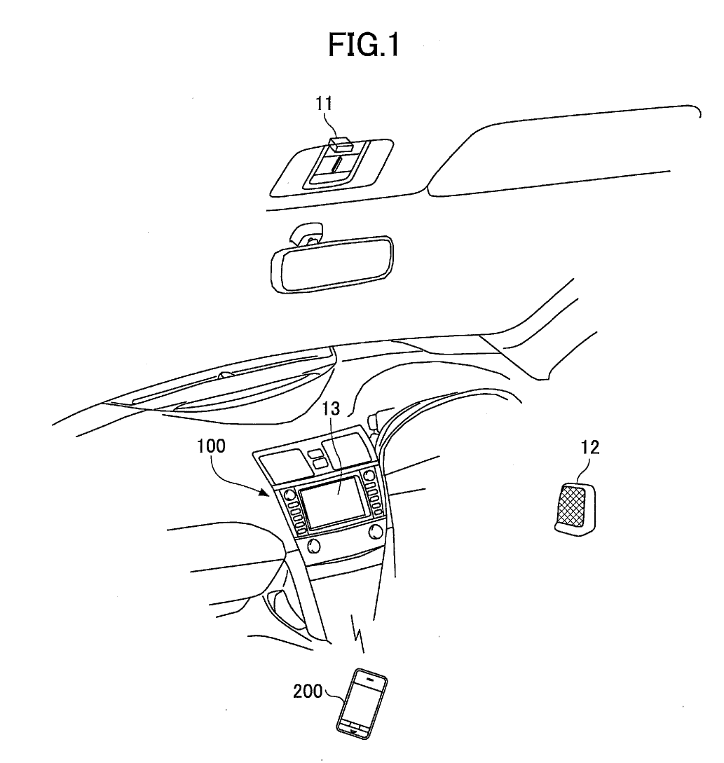

FIG. 1 is a diagram illustrating an in-vehicle apparatus 100 and a mobile terminal 200 according to an embodiment. The in-vehicle apparatus 100 has a microphone 11 to collect sound such as voice and a loudspeaker 12 to output sound, connected via a cable (not illustrated). The in-vehicle apparatus 100 and the mobile terminal 200 are wirelessly connected with each other. Data such as audio data, telephone directory data, and history data are wirelessly transmitted from the in-vehicle apparatus 100 to the mobile terminal 200, or from the mobile terminal 200 to the in-vehicle apparatus 100. Note that the telephone directory data includes full names or names, telephone numbers, types of telephone numbers, and addresses of electronic mail. The type of a telephone number is the type of the telephone having the telephone number associated, such as a fixed-line phone or a cellular phone. The history data includes telephone numbers, dates and times, and the types of history. The type of history may be an incoming call, an outgoing call, or a missed call. Note that the in-vehicle apparatus 100 and the mobile terminal 200 may be connected with each other by wired connection, and data such as audio data, telephone directory data, and history data may be transmitted from the in-vehicle apparatus 100 to the mobile terminal 200, or from the mobile terminal 200 to the in-vehicle apparatus 100, to implement the present embodiment.

The in-vehicle apparatus 100 is an apparatus such as an audio apparatus, a navigation apparatus, a visual apparatus, or an apparatus having such functions built in, and functions as an information display apparatus. The in-vehicle apparatus 100 as an audio apparatus receives broadcast radio waves of the radio or TV to output voice sound and images, reproduces music data stored in a CD (Compact Disc) or a DVD (Digital Versatile Disk) to output the music, or receives music data stored in the mobile terminal 200 to output the music from the loudspeaker 12. The in-vehicle apparatus 100 as a navigation apparatus displays a map and the vehicle position on a display 13, using positional information obtained by a GNSS (Global Navigation Satellite System) and map data.

In order to support a user to enter a call number for hands-free calling, the in-vehicle apparatus 100 transfers the history data and the telephone directory data from the mobile terminal 200 to the in-vehicle apparatus 100. Based on the history data transferred from the mobile terminal 200, the in-vehicle apparatus 100 displays a history list on a display 13.

The mobile terminal 200 as an external terminal may be a cellular phone, a smart phone, or a PHS (Personal Handy-phone System), with which communication can be made in a mobile communication system. The mobile terminal 200 executes wireless communication compliant with wireless communication standards such as GSM (global system for mobile communications)(trademark), PDC (Personal Digital Cellular), CDMA (Code Division Multiple Access), LTE (Long Term Evolution), or WiMAX (Worldwide Interoperability for Microwave Access).

<In-Vehicle Apparatus 100>

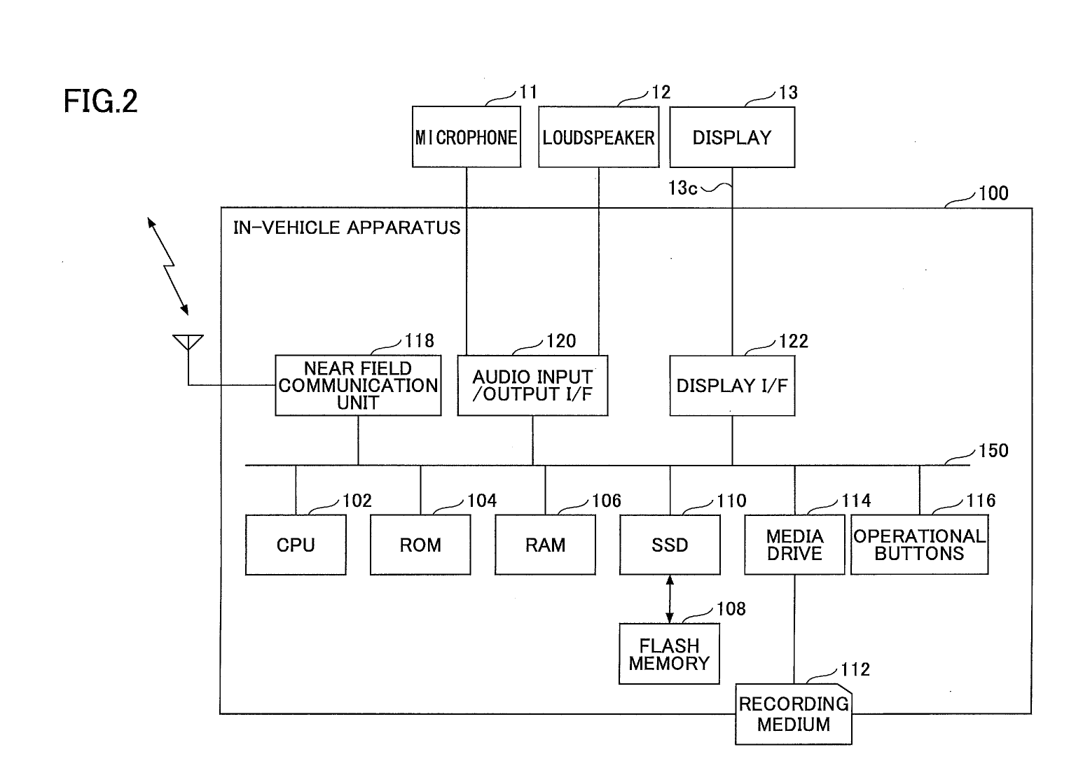

FIG. 2 is a diagram illustrating a hardware configuration of the in-vehicle apparatus 100 according to the present embodiment. As illustrated in FIG. 2, the in-vehicle apparatus 100 includes a CPU (Central Processing Unit) 102 to control operations of the in-vehicle apparatus 100 as a whole; a ROM (Read-Only Memory) 104 to store a program used to drive the CPU 102, such as an IPL (Initial Program Loader); a RAM (Random Access Memory) 106 used for a work area of the CPU 102; a flash memory 108 to store various data such as a program for the in-vehicle apparatus, image data, and audio data; an SSD (Solid State Drive) 110 to control read and write of various data on the flash memory 108 under control of the CPU 102; a media drive 114 to control read or write (storing) of data on a recording medium 112 such as a flash memory; operational buttons 116 operated when selecting a call number or the like; and a near field communication unit 118 to execute data transmission with the mobile terminal 200 using a near field communication technology. An example of the near field communication unit 118 may be a BT module that executes wireless communication following near field communication standards called “Bluetooth (trademark)”. The near field communication unit 118 receives the history data and the telephone directory data transferred from the mobile terminal 200, based on a profile such as a PBAP (Phone Book Access Profile). The PBAP is a pull-type profile that specifies a protocol to transfer telephone directory data or the like. When connected by the PBAP, a user does not need to operate the mobile terminal 200, but just needs to operate the in-vehicle apparatus 100 to transfer the telephone directory data or the like from the mobile terminal 200 to the in-vehicle apparatus 100. Note that Bluetooth (trademark) is just an example of wireless communication standards; any wireless communication standards different from Bluetooth (trademark) may be adopted as long as the transfer order of telephone directory data and history data can be specified, such as ZigBee (trademark) or UWB (Ultra Wide Band).

The in-vehicle apparatus 100 also includes an audio input/output I/F 120 to input/output an audio signal with the microphone 11 or the loudspeaker 12 under control of the CPU 102; a display interface (I/F) 122 to transmit image data to the externally connected display 13, under control of the CPU 102; and a bus line 150 including an address bus and a data bus to electrically connect the units with each other as illustrated in FIG. 2.

The display 13 is a display unit constituted with an LCD or an organic EL (Electro-Luminescence) display to display operational icons and the like. Also, the display 13 is connected with the display I/F 122 by a cable 13c. This cable 13c may be a cable for analog RGB (VGA) signals, a cable for component video, or a cable for HDMI (High-Definition Multimedia Interface) (trademark) or DVI (Digital Video Interactive) signals.

Note that the recording medium 112 can be freely attached to or detached from the in-vehicle apparatus 100. Also, it may not necessarily be the flash memory 108, but may be any other non-volatile memory such as an EEPROM (Electrically Erasable and Programmable ROM) as long as data read and write can be executed under control of the CPU 102.

Furthermore, the program for the in-vehicle apparatus may be recorded on a recording medium readable by a computer, such as the recording medium 112, in an installable or executable file format to be distributed. Also, the program for the in-vehicle apparatus may be stored not in the flash memory 108 but in the ROM 104.

<Mobile Terminal 200>

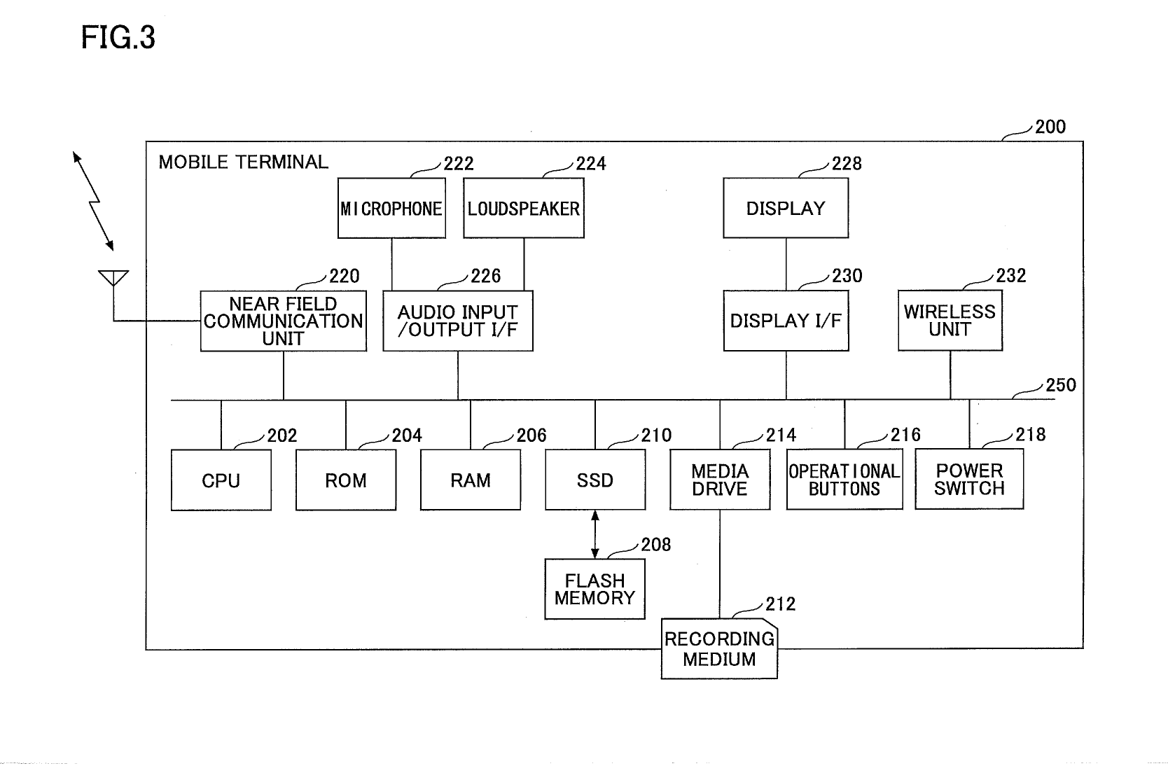

FIG. 3 is a diagram illustrating a hardware configuration of the mobile terminal 200 according to the present embodiment. As illustrated in FIG. 3, the mobile terminal 200 includes a CPU (Central Processing Unit) 202 to control operations of the mobile terminal 200 as a whole; a ROM (Read-Only Memory) 204 to store a program used to drive the CPU 202, such as an IPL (Initial Program Loader); a RAM (Random Access Memory) 206 used for a work area of the CPU 202; a flash memory 208 to store various data such as a program for the mobile terminal, image data, and audio data; an SSD (Solid State Drive) 210 to control read and write of various data on the flash memory 208 under control of the CPU 202; a media drive 214 to control read or write (storing) of data on a recording medium 212 such as a flash memory; operational buttons 216 operated when selecting a communication partner, or the like; a power switch 218 to turn on/off the power source of the mobile terminal 200; and a near field communication unit 220 to execute data transmission with the in-vehicle apparatus 100 using a near field communication technology. An example of the near field communication unit 220 may be a BT module that executes wireless communication following near field communication standards called “Bluetooth (trademark)”. The near field communication unit 220 transfers the history data and the telephone directory data to the in-vehicle apparatus 100, based on a profile such as the PBAP (Phone Book Access Profile). Note that Bluetooth (trademark) is just an example of wireless communication standards; any wireless communication standards different from Bluetooth (trademark) may be adopted as long as the transfer order of telephone directory data and history data can be specified, such as ZigBee (trademark) or UWB.

The mobile terminal 200 also includes a built-in microphone 222 to input voice; a built-in loudspeaker 224 to output voice; and an audio input/output I/F 226 to input/output an audio signal with the microphone 222 or the loudspeaker 224 under control of the CPU 202. The mobile terminal 200 also includes a built-in display 228 constituted with an LCD or an organic EL display to display an image of an object or operational icons or the like; and a display I/F 230 to transmit image data to the display 13 under control of the CPU 202. The mobile terminal 200 also includes a bus line 250 including an address bus and a data bus to electrically connect the units with each other as illustrated in FIG. 3.

Note that the recording medium 212 can be freely attached to or detached from the mobile terminal 200. Also, it is not necessarily the flash memory 208, but may be any other non-volatile memory such as an EEPROM as long as data read and write can be executed under control of the CPU 202.

Furthermore, the program for the mobile terminal may be recorded on a recording medium readable by a computer, such as the recording medium 212, in an installable or executable file format to be distributed. Also, the program for the in-vehicle apparatus may be stored not in the flash memory 208 but in the ROM 204.

<Functional Configuration of In-Vehicle Apparatus 100 and Mobile Terminal 200>

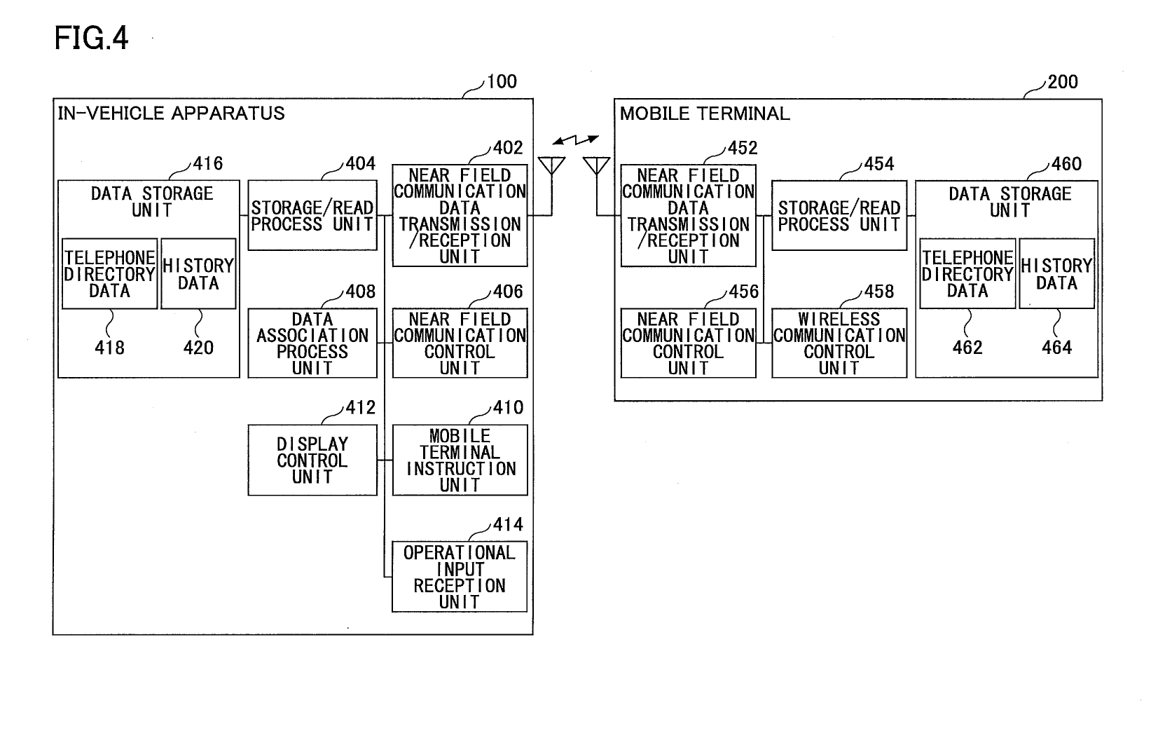

FIG. 4 is a diagram illustrating a functional block diagram of the in-vehicle apparatus 100 and the mobile terminal 200 according to the present embodiment. In FIG. 4, the in-vehicle apparatus 100 and the mobile terminal 200 are wirelessly connected with each other so that data communication can be executed by near field communication.

<Functional Configuration of In-Vehicle Apparatus 100>

The in-vehicle apparatus 100 includes a near field communication data transmission/reception unit 402, a storage/read process unit 404, a near field communication control unit 406, a data association process unit 408, a mobile terminal instruction unit 410, a display control unit 412, an operational input reception unit 414, and a data storage unit 416. These units implement functions realized by the relevant units illustrated in FIG. 2 that operate under instructions from the CPU 102 following the program for the in-vehicle apparatus loaded on the RAM 106 from the flash memory 108. Also, the in-vehicle apparatus 100 includes the data storage unit 416 implemented by the flash memory 108 illustrated in FIG. 2.

(Functional Units of In-Vehicle Apparatus 100)

Next, using FIG. 2 and FIG. 4, functional units of the in-vehicle apparatus 100 will be described in detail. Note that, in the following, when describing the functional units of the in-vehicle apparatus 100, a relationship between the units illustrated in FIG. 2 may be described that is relevant to implement the functional units of the in-vehicle apparatus 100.

The near field communication data transmission/reception unit 402 of the in-vehicle apparatus 100 illustrated in FIG. 4 is implemented by instructions from the CPU 102 illustrated in FIG. 2 and the near field communication unit 118 illustrated in FIG. 2, to receive and transmit various data with the mobile terminal 200 by near field communication. When a user holding the mobile terminal 200 comes into an area where the near field communication unit 118 can make wireless communication, the near field communication data transmission/reception unit 402 executes a connection process with the mobile terminal 200.

Here, communication between the in-vehicle apparatus 100 and the mobile terminal 200 will be described. When making wireless communication between the in-vehicle apparatus 100 and the mobile terminal 200 for the first time by Bluetooth (trademark), a user enters a PIN (personal identification number) code (also referred to as a “passkey”) specified by the in-vehicle apparatus 100 into the mobile terminal 200. The in-vehicle apparatus 100 and the mobile terminal 200 identify each other by the PIN code. The in-vehicle apparatus 100 generates a link key specific to the two apparatuses, to transmit it to the mobile terminal 200 (pairing). Once the pairing has been done, the in-vehicle apparatus 100 and the mobile terminal 200 store the link key, respectively. Therefore, just by bringing the mobile terminal 200 into the communication range of the in-vehicle apparatus 100, the in-vehicle apparatus 100 can authenticate the mobile terminal 200 using the link key to make communication.

To guarantee communications among various apparatuses, Bluetooth (trademark) specifies various profiles for possible use. To make communication between two apparatuses, the two apparatuses need to implement the same profile. A GAP (Generic Access Profile), a SDAP (Service Discovery Application Profile), a SPP (Serial Port Profile) or the like are basic profiles, which are implemented in a lower layer (by hardware). The in-vehicle apparatus 100 and the mobile terminal 200 have the. PBAP for reception/transmission of the telephone directory data as an upper layer of these general profiles. The PBAP is a profile to obtain the telephone directory data or the like from the mobile terminal 200 by the in-vehicle apparatus 100 without having a user operate the mobile terminal 200.

Also, for hands-free calling, the in-vehicle apparatus 100 and the mobile terminal 200 may have a HFP (Hands-Free Profile). The HFP specifies input and output of voice, AT command handling, notification of the strength of radio waves and a caller number, use of redialing and a telephone directory function, echo cancelling, and the like. These profiles are implemented in an IC chip or a protocol stack (software), which may be included in a navigation/audio board instead of the near field communication unit 118 due to restrictions on development and cost.

The storage/read process unit 404 of the in-vehicle apparatus 100 is implemented by instructions from the CPU 102 illustrated in FIG. 2 and the SSD 110 illustrated in FIG. 2, to store various data in the data storage unit 416, and to read the various data stored in the data storage unit 416.

The data storage unit 416 of the in-vehicle apparatus 100 stores the telephone directory data 418 and the history data 420 as an example of a database. The telephone directory data 418 and the history data 420 stored in the data storage unit 416 are not deleted when the engine of a vehicle having the in-vehicle apparatus 100 built in is turned off.

The near field communication control unit 406 of the in-vehicle apparatus 100 is implemented by instructions from the CPU 102 illustrated in FIG. 2 and the near field communication unit 118 illustrated in FIG. 2, to control an obtainment process of the history data and the telephone directory data wirelessly transmitted from the mobile terminal 200 by near field communication.

The data association process unit 408 of the in-vehicle apparatus 100 is implemented by instructions from the CPU 102 illustrated in FIG. 2, to associate a telephone number constituting the history data 464 wirelessly transmitted from the mobile terminal 200 by near field communication, with a telephone number constituting the telephone directory data 418 stored in the data storage unit 416 so that the telephone number constituting the history data 464 corresponds to the telephone number constituting the telephone directory data 418 by the association, and to identify the full name or name corresponding to the telephone number constituting the history data 464. Namely, the data association process unit 408 extracts the same telephone number as the telephone number constituting the history data 464 wirelessly transmitted from the mobile terminal 200, among telephone numbers constituting the telephone directory data 418 stored in the data storage unit 416, to associate them with each other. Then, the data association process unit 408 identifies the full name or name having the telephone number associated that has been extracted among the telephone numbers constituting the telephone directory data 418 stored in the data storage unit 416.

The display control unit 412 of the in-vehicle apparatus 100 is implemented by instructions from the CPU 102 illustrated in FIG. 2 and the display I/F 122 illustrated in FIG. 2, to control transmission of image data to the display 13. For example, when displaying a history list based on the history data 464 wirelessly transmitted from the mobile terminal 200, the display control unit 412 controls replacing the telephone number in the history data 464, with the full name or name corresponding to the telephone number in the history data 464 identified by the data association process unit 408, to be displayed on the display 13.

The operational input reception unit 414 of the in-vehicle apparatus 100 is implemented by instructions from the CPU 102 illustrated in FIG. 2 and the operational buttons 116 illustrated in FIG. 2, to receive various inputs from a user.

The mobile terminal instruction unit 410 of the in-vehicle apparatus 100 is implemented by instructions from the CPU 102 illustrated in FIG. 2 and the operational buttons 116 illustrated in FIG. 2, to indicate a calling number, which is a telephone number corresponding to a full name or name specified by a user who refers to the history list and operates the operational buttons 116, by wirelessly transmitting the calling number from the near field communication data transmission/reception unit 402 to the mobile terminal 200.

<Functional Configuration of Mobile Terminal 200>

The mobile terminal 200 includes a near field communication data transmission/reception unit 452, a storage/read process unit 454, a near field communication control unit 456, a wireless communication control unit 458, and a data storage unit 460. These units implement functions realized by the relevant units illustrated in FIG. 3 that operate under instructions from the CPU 202 following the program for the mobile terminal loaded on the RAM 206 from the flash memory 208. Also, the mobile terminal 200 includes the data storage unit 460 implemented by the flash memory 208 illustrated in FIG. 3.

(Functional Units of Mobile Terminal 200)

Next, using FIG. 3 and FIG. 4, functional units of the mobile terminal 200 will be described in detail. Note that, in the following, when describing the functional units of the mobile terminal 200, a relationship between the units illustrated in FIG. 3 may be described that is relevant to implement the functional units of the mobile terminal 200.

The near field communication data transmission/reception unit 452 of the mobile terminal 200 illustrated in FIG. 4 is implemented by instructions from the CPU 202 illustrated in FIG. 3 and the near field communication unit 220 illustrated in FIG. 3, to receive and transmit various data with the in-vehicle apparatus 100 by near field communication. When a user holding the mobile terminal 200 comes into an area where the near field communication unit 118 of the in-vehicle apparatus 100 can make wireless communication, the near field communication data transmission/reception unit 452 executes a connection process with the in-vehicle apparatus 100. Communication between the in-vehicle apparatus 100 and the mobile terminal 200 has been described above, which is omitted here.

The storage/read process unit 454 of the mobile terminal 200 is implemented by instructions from the CPU 202 illustrated in FIG. 3 and the SSD 210 illustrated in FIG. 3, to store various data in the data storage unit 460, and to read the various data stored in the data storage unit 460. The data storage unit 460 stores the telephone directory data 462 and the history data 464 as an example of a database.

The near field communication control unit 456 of the mobile terminal 200 is implemented by instructions from the CPU 202 illustrated in FIG. 3 and the near field communication unit 220 illustrated in FIG. 3, to control a transmission process of the history data 464 and the telephone directory data 462 by near field communication.

The wireless communication control unit 458 of the mobile terminal 200 is implemented by instructions from the CPU 202 illustrated in FIG. 3 and the wireless unit 232 illustrated in FIG. 3, to make a call to a telephone number specified by a user, by wireless communication in a mobile communication system. For example, when the telephone number information wirelessly transmitted from the in-vehicle apparatus 100 is received by the near field communication data transmission/reception unit 452, the wireless communication control unit 458 makes a call to the telephone number.

<Operations of In-Vehicle Apparatus 100 and Mobile Terminal 200>

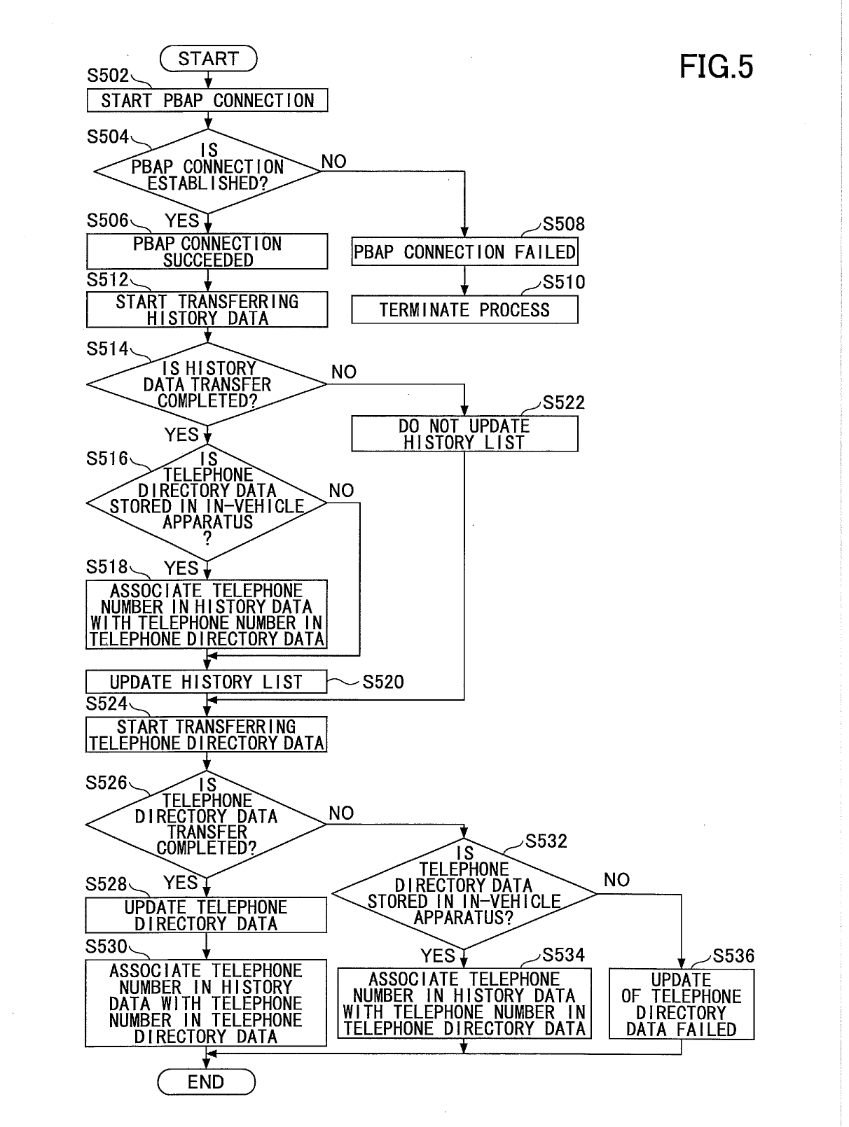

FIG. 5 is a flowchart illustrating operations of the in-vehicle apparatus 100 and the mobile terminal 200 according to the present embodiment.

At Step S502, a connection process starts between the near field communication data transmission/reception unit 402 of the in-vehicle apparatus 100, and the near field communication data transmission/reception unit 452 of the mobile terminal 200 following the PBAP connection protocol. Specifically, when a user carrying the mobile terminal 200 comes into an area where communication can be made with the in-vehicle apparatus 100, a connection process starts between the in-vehicle apparatus 100 and the mobile terminal 200 following the PBAP connection protocol.

At Step S504, the near field communication data transmission/reception unit 402 of the in-vehicle apparatus 100, and the near field communication data transmission/reception unit 452 of the mobile terminal 200 determine whether the connection is established by the PBAP connection protocol.

At Step S506, the near field communication data transmission/reception unit 402 of the in-vehicle apparatus 100, and the near field communication data transmission/reception unit 452 of the mobile terminal 200 determine that the connection has succeeded if the connection is established by the PBAP connection protocol.

At Steps S508 and S510, the near field communication data transmission/reception unit 402 of the in-vehicle apparatus 100, and the near field communication data transmission/reception unit 452 of the mobile terminal 200 determine that the connection has failed if the connection is not established by the PBAP connection protocol fail, and terminate the process thereafter.

At Step S512, the near field communication control unit 456 of the mobile terminal 200 has the storage/read process unit 454 read the history data 464 stored in the data storage unit 460. The near field communication control unit 456 has the near field communication data transmission/reception unit 452 transmit the history data 464 to the in-vehicle apparatus 100, to start transferring the history data 464. In this way, the telephone directory data and the history data can be automatically transferred from the mobile terminal 200 to the in-vehicle apparatus 100.

At Step S514, the near field communication control unit 406 of the in-vehicle apparatus 100 determines whether the reception of the history data is completed, which history data is transferred from the mobile terminal 200, and received by the near field communication data transmission/reception unit 402. While receiving the history data transferred from the mobile terminal 200, the near field communication control unit 406 may have the display control unit 412 display that a history list is being updated.

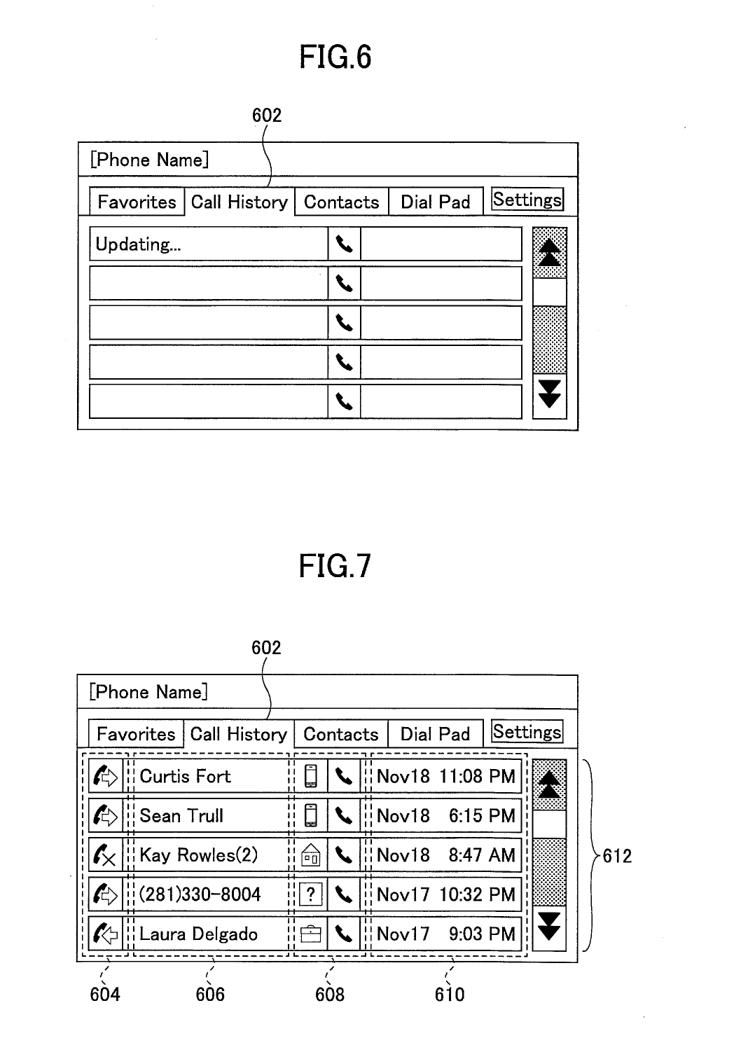

FIG. 6 is a diagram illustrating an example of a display showing that a history list 602 is being updated. When the history list (Call History) 602 is being updated, a message is displayed to indicate updating the history list 602. Thus, a user can recognize that the history data 464 is being received.

If the near field communication control unit 406 of the in-vehicle apparatus 100 determines that the reception of the history data is completed, then, at Step S516, the data association process unit 408 determines whether the telephone directory data 418 is stored in the data storage unit 416 by having the storage/read process unit 404 read data stored in the data storage unit 416. Thus, it is possible to determine whether the telephone directory data 418 is stored in the in-vehicle apparatus 100 to identify the full name or name to be displayed instead of the telephone number constituting the history data 464 transmitted from the mobile terminal 200.

If the telephone directory data 418 is stored in the data storage unit 416, then, at Step S518, the data association process unit 408 of the in-vehicle apparatus 100 associates the telephone numbers constituting the history data 464 received at Step S514, with telephone numbers constituting the telephone directory data 418 stored in the data storage unit 416. Thus, the telephone numbers constituting the history data 464, which have the respective telephone numbers constituting the telephone directory data 418 associated, can have the respective full names or names associated.

At Step S520, the display control unit 412 of the in-vehicle apparatus 100 updates the history list based on the history data 464 received at Step S514. When updating the history list, if the data association process unit 408 has associated the telephone numbers constituting the history data 464 received at Step S514, with telephone numbers constituting the telephone directory data 418 stored in the data storage unit 416, the display control unit 412 displays the full names or names corresponding to the telephone numbers constituting the telephone directory data 418 that have been associated, instead of the telephone numbers constituting the history data 464.

FIG. 7 is a diagram illustrating a first update example of a history list. FIG. 7 illustrates a history list 602 that is displayed when there are telephone numbers constituting the history data 464 transmitted from the mobile terminal 200 that have telephone numbers constituting the telephone directory data 418 stored in the data storage unit 416 associated, while updating the history list 602.

The history list 602 shows the type of history 604, the full name or name 606, the type of telephone number 608, and date and time 610. Further, by vertically scrolling a scroll bar 612, a history list not fit in the display 13 can be displayed. The type of history 604 indicates an “incoming call” or an “outgoing call” by an arrow “→” or ←”, or indicates a missed call by “x”. The full name or name 606 may be displayed as a telephone number for a telephone number constituting the history data 464 that does not have a telephone number constituting the telephone directory data 418 stored in the data storage unit 416 associated.

As illustrated in FIG. 7, when reception of the history data 464 transmitted from the mobile terminal 200 is completed, if the in-vehicle apparatus 100 stores the telephone directory data 418, telephone numbers constituting the history data 464 can have telephone numbers constituting the telephone directory data 418 associated. Therefore, the telephone numbers constituting the history data 464, the telephone numbers constituting the telephone directory data 418, and the full names or names of the telephone directory data 418 can be associated with each other. Thus, instead of the telephone numbers constituting the history data 464, the full names or names can be displayed that correspond to the telephone numbers constituting the telephone directory data 418 by the association.

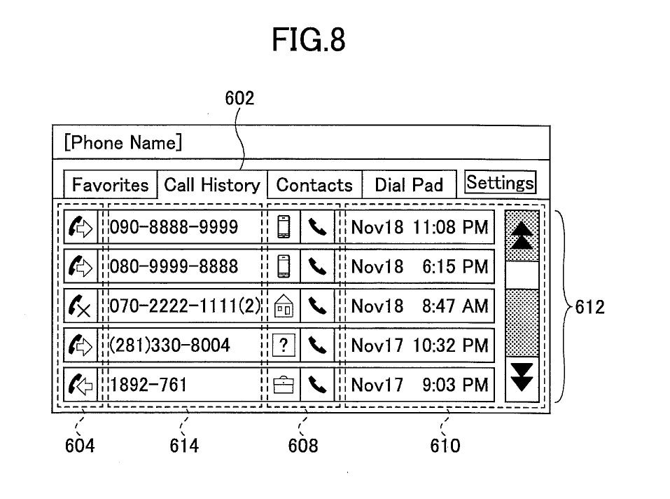

FIG. 8 is a diagram illustrating a second update example of a history list. FIG. 8 illustrates a history list 602 that is displayed when no telephone numbers constituting the history data 464 have telephone numbers constituting the telephone directory data 418 stored in the data storage unit 416 associated, while updating the history list 602.

As illustrated in FIG. 8, when reception of the history data 464 is completed, if the in-vehicle apparatus 100 does not store the telephone directory data 418, no telephone number constituting the history data 464 can have a telephone number that would constitute the telephone directory data 418 associated. Therefore, the telephone numbers constituting the history data 464, the telephone numbers that would constitute the telephone directory data 418, and the full names or names of the telephone directory data 418 cannot be associated with each other. In this case, the history list 602 shows telephone numbers constituting the history data 464, dates and times. Thus, a user can refer to the history list before the reception of the telephone directory data is completed, to quickly recognize that there have been missed calls.

Referring to FIG. 5 again, the flowchart will be further described.

At Step S522, the display control unit 412 of the in-vehicle apparatus 100 does not update the history list 602 if the reception of the history data 464 is not completed that is transferred from the mobile terminal 200 by the near field communication control unit 406 of the in-vehicle apparatus 100. Thus, if an interrupt such as ACC OFF or the like is generated or the history data 464 transferred from the mobile terminal 200 cannot be received correctly while receiving the history data 464 transferred from the mobile terminal 200, the in-vehicle apparatus 100 can be prevented from freezing.

At Step S524, after the history list has been updated at Step S520, or the history list has not been updated at Step S522, the near field communication control unit 456 of the mobile terminal 200 has the storage/read process unit 454 read the telephone directory data 462 stored in the data storage unit 460. The near field communication control unit 456 has the near field communication data transmission/reception unit 452 transmit the telephone directory data 462 to the in-vehicle apparatus 100, to start transferring the telephone directory data 462.

At Step S526, the near field communication control unit 406 of the in-vehicle apparatus 100 determines whether the reception of the telephone directory data 462 is completed, which telephone directory data 462 is transferred from the mobile terminal 200, and received by the near field communication data transmission/reception unit 402. While receiving the telephone directory data 462 transferred from the mobile terminal 200, the near field communication control unit 406 may have the display control unit 412 display that the telephone directory is being updated. Thus, a user can recognize that the telephone directory data 462 is being received.

If the near field communication control unit 406 of the in-vehicle apparatus 100 determines that the reception of the telephone directory data 462 is completed, then, at Step S528, the near field communication control unit 406 updates the telephone directory data 418 based on the telephone directory data 462.

At Step S530, the data association process unit 408 of the in-vehicle apparatus 100 has the storage/read process unit 404 read the history data 420 stored in the data storage unit 416, to associate telephone numbers constituting the history data 420 with telephone numbers constituting the telephone directory data 418 updated at Step S528. Thus, a telephone number having been displayed because it cannot have a telephone number in the history list updated at Step S520 associated, now has a telephone number constituting the telephone directory data 462 received at Step S526 associated, and the full name or name can be displayed.

If the near field communication control unit 406 of the in-vehicle apparatus 100 determines that the reception of the telephone directory data 462 is not completed, then, at Step S532, the data association process unit 408 has the storage/read process unit 404 read data stored in the data storage unit 416, to determine whether the telephone directory data 418 is stored in the data storage unit 416.

If determining that the telephone directory data 418 is stored in the data storage unit 416, then at Step S534, the data association process unit 408 of the in-vehicle apparatus 100 associates a telephone number constituting the history data 420 with a telephone number constituting the telephone directory data 418. Thus, by associating the telephone numbers constituting the history data 420, the telephone numbers constituting the telephone directory data 462, and the full names or names of the telephone directory data 462 with each other, the full names or names can be displayed instead of the telephone numbers constituting the history data 420. For example, while receiving the telephone directory data 462 transmitted from the mobile terminal 200, when the history data 420 is changed for an incoming call, an outgoing call, or a missed call, the full name or name can be displayed instead of the telephone number constituting the history data 420.

If determining that the telephone directory data 418 is not stored in the data storage unit 416, then at Step S536, the data association process unit 408 of the in-vehicle apparatus 100 determines that the update of the telephone directory has failed. When determining that the update of the telephone directory has failed, the data association process unit 408 may indicate it a user.

In the embodiment described above, the telephone directory data and the history data are described as an example of a database. Alternatively, the embodiment can be applied to alarm information, schedule information, coupon information, and the like. For example, alarm information may include the name of an alarm and the identifier of the alarm, and the history of the alarm includes the identifier of the alarm, and the date and time of the alarm. In this case, when displaying the history of an alarm, the alarm identifier of the alarm information has the alarm identifier of the history of the alarm associated, and hence, the name of the alarm can be displayed instead of the identifier of the alarm. Also, for example, schedule information may include the name of a schedule and the identifier of the schedule, and the history of the schedule includes the identifier of the schedule, and the date and time of the schedule. In this case, when displaying the history of a schedule, the schedule identifier of the schedule information has the schedule identifier of the history of the schedule associated, and hence, the name of the schedule can be displayed instead of the identifier of the schedule. Also, for example, coupon information may include the name of a coupon and the identifier of the coupon, and the history of the coupon includes the identifier of the coupon, and the date and time of the coupon. In this case, when displaying the history of a coupon, the coupon identifier of the coupon information has the coupon identifier of the history of the coupon associated, and hence, the name of the coupon can be displayed instead of the identifier of the coupon.

As described above, according to at least one embodiment of the in-vehicle apparatus, by obtaining history data before telephone directory data, and associating the history information that is obtained first with telephone directory data that has been already obtained, it possible to display a full name or name instead of a telephone number when displaying a history list, and hence, a user can easily recognize a person whose call is left in the history list.

The present invention has been described with reference to the embodiments, which are just examples, and one skilled in the art will understand that variations, modifications, alternatives, and replacements can be made. Although the apparatus according to the embodiments of the present invention is described using functional block diagrams for the sake of explanation, the apparatus may be implemented by hardware, software, or a combination of hardware and software. The present invention is not limited to the embodiments described above, but variations, modifications, alternatives, and replacements may be made without departing from the scope of the present invention.

The present application is based on Japanese Priority Application No. 2014-099786, filed on May 13, 2014, the entire contents of which are hereby incorporated by reference.

What is claimed is:

1. An information display apparatus configured to display database information obtained from an outside, comprising:
a control unit configured to execute control for, when newly obtaining the database information from the outside,
obtaining history information about the database information to be newly obtained from the outside, earlier than obtaining the database information to be newly obtained, and
associating the history information with the database information that has already been obtained, to display the history information including the database information that has already been obtained.

2. The information display apparatus, as claimed in claim 1, wherein, when newly obtaining the database information from the outside, if the database information has never been obtained before the database information to be newly obtained, the control unit executes control to display the history information.

3. The information display apparatus, as claimed in claim 1, wherein the database information is telephone directory data, and the history information is history data,
wherein the control unit executes control for associating a telephone number in the history data, with a corresponding telephone number in the telephone directory data, to display a history list using a full name or name corresponding to the corresponding telephone number in the telephone directory data.

4. An in-vehicle apparatus configured to be built in a vehicle, comprising:
the information display apparatus as claimed in claim 1.

5. A data update method executed by an information display apparatus configured to display database information obtained from an outside, the method comprising:
executing control when newly obtaining the database information from the outside, by
obtaining history information about the database information to be newly obtained from the outside, earlier than obtaining the database information to be newly obtained, and
associating the history information with the database information that has already been obtained, to display the history information including the database information that has already been obtained.
